(19) United States
(12) Patent Application Publication
(10) Pub. No.: US 2008/0240286 A1
(43) Pub. Date: Oct. 2, 2008

(54) SIGNAL TRANSMISSION SYSTEM, METHOD AND APPARATUS

(75) Inventors: Hui Zhang, Beijing (CN); Stanley Wang, Beijing (CN); Jianghul Zhang, Beijing (CN)

Correspondence Address: CALFEE HALTER & GRISWOLD, LLP, 800 SUPERIOR AVENUE, SUITE 1400, CLEVELAND, OH, 44114, US

(73) Assignee: INNOFIDEI, INC., Beijing (CN)

(21) Appl. No.: 12/025,846

(22) Filed: Feb. 5, 2008

(30) Foreign Application Priority Data
Mar. 26, 2007 (CN) 200710064792.9
Mar. 26, 2007 (CN) 200710064793.3

(51) Int. Cl. H04L 25/03; H04L 25/49

(52) U.S. Cl. 375/296

(57) ABSTRACT

The invention discloses a signal transmission system, method and apparatus, and relates to the fields of communications and broadcast television. It is intended to reduce the hardware cost of the signal transmitting system. The system according to the invention is based on a personal computer operating system, and comprises a computer and a transmitting equipment, said computer comprising a signal source processing module for processing a signal source, a channel encoding and modulating module for channel encoding and modulating of the processed signal source, and an interface module for outputting the data encoded and modulated by the channel encoding and modulating module, and said transmitting equipment being arranged to receive data from the interface module, process the received data into a radio frequency RF signal, and then transmit the RF signal. The invention may be applicable to a transmitter of broadcast television.

### FIELD OF THE INVENTION

The invention relates to the fields of communications and broadcasting system, in particular to a signal transmission system, method and apparatus.

### BACKGROUND ART

Currently, the signal sources of a digital television transmitter and tested equipment are mostly provided by an exciter with a corresponding mechanism. The main functions of the exciter are channel coding, modulation and up-conversion, the purpose of which is to enhance its anti-interference capability and ensure that a digital television signal can be correctly transmitted and received. After it is inputted to the exciter, a transmission stream TS signal is channel encoded and modulated, and a standard analog baseband or Intermediate frequency (IF) signal is outputted and then up-converted to RF signal of a desired channel, which RF signal is outputted, further amplified by a RF amplifier of the digital television transmitter and then transmitted.

The nowaday digital television exciters all employ the hardware modulation technique. Generally, an FPGA (Field Programmable Gate Arrays) is used to carry out the TS channel encoding and modulation, and then the modulated baseband data is transmitted in accordance with a certain time relationship.

Implementing transmission of a RF signal with the hardware modulation technique (generally using an FPGA), however, has the following disadvantages:

1. The software and hardware cost of the part of the channel encoding and modulation is very high. The channel encoding and modulation is a highly complex procedure, and is a technique in the digital domain, the nowaday products of which are usually implemented by using an FPGA. Because of the algorithmic complexity, the resources occupied are many, and the scale of FPGA used is large. As a consequence, its cost is high.

2. The system of channel encoding is relatively complicated, while development of the FPGA encode also needs dedicated environments.

3. The pre-distortion part also requires an FPGA to be used. Since the algorithm is complex and needs a certain amount of computation, the scale of FPGA occupied is large. Moreover, due to the existence of the transfer links between hardware, the reliability is reduced.

4. The input of the exciter is TS, and the output is a modulated RF signal. Therefore the exciter can be used as a signal source, but its cost is relatively high for a common signal source used in industry. As a signal source, it is desired to provide not only a RF signal, but also a digital baseband signal or an analog baseband sisal, or a digital IF signal or an analog IF signal under certain circumstances, for example, when testing the performance of a receiver module by module.

From the above description, it can be seen that the cost of prior art RF signal transmission implementation is high, and in addition, due to many physical transmission link, the reliability of signal is low. Furthermore, since the RF signal transmission is performed by the hardware modulation technique, it is not flexible for changing system parameters and increasing or decreasing functions in the digital domain; moreover, the kinds of signal sources that can be outputted are few.

Furthermore, the input of prior art exciter is TS, and the output can only be a modulated RF signal. For a common signal source used in industry, its cost is relatively high. As a test signal source, it is desired for it to provide not only a RF signal, but also a digital baseband signal, an analog baseband signal, a digital IF signal or an analog IF signal under certain circumstances, for example, when testing the performance of a receiver module by module, however, the exciter device can not provide these test signals.

### SUMMARY OF THE INVENTION

The invention is intended to provide a signal transmission system, method and apparatus in order to reduce the hardware cost of the signal transmitting system. The invention also provides further improved technical solutions of said signal transmission system and method, which improved technical solutions may extract as test signals the intermediate signals generated in the course of processing of signals from a source signal to a RF signal.

The signal transmitting system according to the invention is based on a personal computer PC operating system, and comprises a PC and a transmitting equipment, said PC comprising a signal source processing module for processing a signal source, a channel encoding and modulating module for channel encoding and modulating of the processed signal source, and an interface module for outputting the data encoded and modulated by the channel encoding and modulating module, and said transmitting equipment being arranged to receive data from the interface module, process the received data into a radio frequency RF signal, and then transmit the RF signal.

In a preferred embodiment according to the invention, between the channel encoding and modulating module and the interface module is also comprised a pre-distortion processing module for, in the case of a high power amplifier being driven, pre-distortion processing of data outputted by the channel encoding and modulating module, which data are then outputted by the interface module.

In a preferred embodiment according to the invention, said PC also comprises a system parameters setting module for setting relevant parameters required by the signal source processing module, the channel encoding and modulating module and/or the transmitting equipment.

In a preferred embodiment according to the invention, said PC further comprises a system parameters display module for displaying the parameters currently used by the signal source processing module, the channel encoding and modulating module and/or the transmitting equipment.

In a preferred embodiment according to the invention, said PC further comprises an output module, which output module is connected to the signal source processing module and/or the channel encoding and modulating module, and arranged to output a signal processed by the signal source processing module and/or the channel encoding and modulating module.

In summary, said transmitting equipment comprises a digital to analog conversion module for performing a digital to analog conversion, an quadrature modulation unit for orthogonally frequency up-converting of a baseband signal into a IF signal, and a RF outputting module for processing the IF signal into a RF signal and outputting the RF signal.

In the aforementioned improved technical solution of said signal transmitting system, said signal transmitting system further provides a desired test signal.

In this improved technical solution, said signal transmitting system further comprises an extracting unit for extracting a signal outputted by a relevant unit to a corresponding succeeding unit in the signal transmitting system.

In a preferred embodiment according to said improved technical solution, said signal transmitting system further comprises therein a filter for filtering data outputted by the channel encoding and modulating module, generating a digital baseband signal and outputting the digital baseband signal, and the digital baseband signal outputted by the filter is extracted by said extracting unit.

In a preferred embodiment according to said improved technical solution, said signal transmitting system further comprises therein a filter for filtering data outputted by the channel encoding and modulating module, generating a digital baseband signal and outputting the digital baseband signal, and a digital to analog conversion unit for converting the digital baseband signal outputted by the filter into an analog baseband signal and outputting the analog baseband signal, and the analog baseband signal outputted by the digital to analog conversion unit is extracted by said extracting unit.

In a preferred embodiment according to said improved technical solution, said signal transmitting system further comprises therein a filter for filtering data outputted by the channel encoding and modulating module, generating a digital baseband signal and outputting the digital baseband signal, and an quadrature modulation unit for orthogonally frequency up-converting of the digital baseband signal outputted by the filter into a digital IF signal and outputting the digital IF signal and the digital IF signal outputted by the quadrature modulation unit is extracted by said extracting unit.

In a preferred embodiment according to said improved technical solution, said signal transmitting system further comprises therein a filter for filtering data outputted by the channel encoding and modulating module, generating a digital baseband signal and outputting the digital baseband signal, an quadrature modulation unit for orthogonally frequency up-converting of the digital baseband signal outputted by the filter into a digital IF signal and outputting the digital IF signal, and a digital to analog conversion unit for converting the digital IF signal outputted by the quadrature modulation unit into an analog IF signal and outputting the analog IF signal, and the analog IF signal outputted by the digital to analog conversion unit is extracted by said extracting unit.

To summarize, said extracting unit extracts a signal in the form of TTL or LVDS.

A personal computer according to the invention comprises a signal source processing module for processing a signal source, a channel encoding and modulating module for channel encoding and modulating of the processed signal source, and an interface module for outputting data encoded and modulated by the channel encoding and modulating module.

In a preferred embodiment according to the invention, between the channel encoding and modulating module and the interface module is also comprised a pre-distortion processing module for, in the case of a high power amplifier being driven, pre-distortion processing of data outputted by the channel encoding and modulating module, which data are then outputted by the interface module.

In a preferred embodiment according to the invention, said PC also comprises a system parameters setting module for setting relevant parameters required by the signal source processing module, the channel encoding and modulating module and/or an external device connected to the PC.

In a preferred embodiment according to the invention, said PC further comprises a system parameters display module for displaying the parameters currently used by the signal source processing module, the channel encoding and modulating module and/or an external device connected to the PC.

In a preferred embodiment according to the invention, said PC further comprises an output module, which output module is connected to the signal source processing module and/or the channel encoding and modulating module, and arranged to output a signal processed by the signal source processing module and/or the channel encoding and modulating module.

A signal transmitting method according to the invention for use in a system having a PC and a transmitting equipment, comprises the following steps:

the personal computer PC performs signal source processing,

the PC carries out the operation of channel encoding and modulating on the processed signal source,

the PC outputs the encoded and modulated data, and

the transmitting equipment processes data received from said PC into a radio frequency RF signal and transmits the RF signal.

In a preferred embodiment according to the invention, said PC performs pre-distortion processing on the channel encoded and modulated data before outputting the encoded and modulated data.

In a preferred embodiment according to the invention, parameters necessary for the signal source processing and the channel encoding and modulation performed by said PC, and the data processing performed by the transmitting equipment are set in said PC.

In a preferred embodiment according to the invention, said PC, after processing a signal source, outputs a signal obtained by signal source processing, and/or said PC, after performing the operation of channel encoding and modulation, outputs a signal obtained by channel encoding and modulating.

In the aforementioned improved technical solution of said signal transmitting method, said signal transmitting method further provides a desired test signal.

In this improved technical solution, said signal transmitting method further comprises the steps of generating an intermediate signal in the course of processing of signals from a source signal to a RF signal and extracting the intermediate signal.

The advantageous effects of the invention are as follows:

The invention is based on a PC operating system, achieves the functions of signal source processing and channel encoding and modulation in the signal transmitting system by means of software, outputs data via the interface module to the transmitting equipment (a hardware device) after the data have been channel encoded and modulated, processes the data into a RF signal and transmits the RF signal.

Since, in the signal transmitting system, part of hardware functions is realized by means of PC software, hardware cost of the signal transmitting system is reduced. Since, in the signal transmitting system, part of hardware functions is realized by means of PC software, the number of physical transmitting links is decreased and the reliability of signal transmission is increased.

Furthermore, since the processing procedure before data processing is realized by means of PC software, increase or decrease of functions in the digital domain is more flexible, and compatibility of the system is improved, for example, the linear distortion, nonlinear distortion, etc. can be increased. Since the invention is based on a PC operating system, a setting, changing and displaying platform for system parameters can be easily provided. The invention may also supply any of the intermediate signals, providing a developmental environment of the transmitting end, and enriches test signals and increases testing means for a receiving device.

Said improved technical solution further possesses the following advantageous effects.

In the signal transmitting system, the invention extracts the intermediate signals generated in the course of processing of signals from a source signal to a RF signal. In addition, it explicitly extracts a signal in the form of TTL or LVDS. Therefore, a desired test signal may be obtained, and the demand may be met for, for example, testing the performance of a receiver module by module. The invention provides a developmental environment of the transmitting end, enriches test signals and increases testing means for a receiving device.

### BRIEF DESCRIPTION OF THE DRAWINGS

FIG. 1 shows a schematic diagram of the structure of a signal transmitting system according to the invention,

FIG. 2 shows a schematic diagram of the structure of the signal transmitting system of a first embodiment according to the invention,

FIG. 3 shows a schematic diagram of the structure of the signal transmitting system of a second embodiment according to the invention,

FIG. 4 shows a schematic diagram of the structure of the signal transmitting system of a third embodiment according to the invention,

FIG. 5 shows a schematic diagram of the structure of the signal transmitting system of a fourth embodiment according to the invention,

FIG. 6 shows a flow chart of said signal transmitting method of an embodiment according to the invention,

FIG. 7 shows a schematic diagram of the structure of an improved technical solution of said signal transmitting system according to the invention, which technical solution can provide a test signal,

FIG. 8 shows a flow chart of an improved technical solution of said signal transmitting method according to the invention, which technical solution can provide a test signal,

FIG. 9 shows a modularized processing flow chart of a first embodiment of said improved technical solution that can provide a test signal,

FIG. 10 shows a modularized processing flow chart of a second embodiment of said improved technical solution that can provide a test signal,

FIG. 11 shows a modularized processing flow chart of a third embodiment of said improved technical solution that can provide a test signal,

FIG. 12 shows a modularized processing flow chart of a fourth embodiment of said improved technical solution that can provide a test signal.

### DETAILED DESCRIPTION OF THE INVENTION

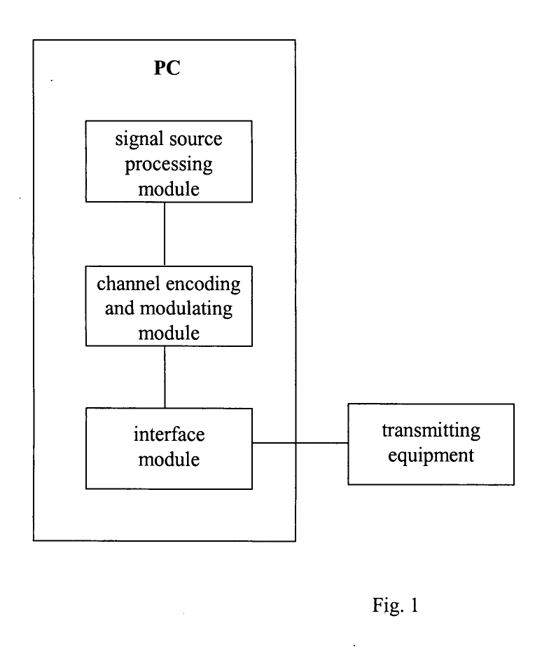

The present invention provides a signal transmitting system to reduce the cost of the signal transmitting system, which signal transmitting system is based on a PC operating system as shown in FIG. 1, and comprises a PC and a transmitting equipment. Said PC comprises therein a signal source processing module, a channel encoding and modulating module and an interface module that are successively connected, the interface module being connected to the transmitting equipment.

Said signal source processing module is implemented by means of PC software and arranged to perform the signal source processing.

Said channel encoding and modulating module is implemented by means of PC software and arranged to perform the channel encoding and modulating of the processed signal source.

Said interface module, such as a USB interface or a PCI interface, is arranged to output data encoded and modulated by the channel encoding and modulating module.

Said transmitting equipment is arranged to receive data from the interface module, process the received data into a radio frequency RF signal and transmit the RF signal. The function of the transmitting equipment is realized by hardware, such as a piece of FPGA. Said transmitting equipment may comprise a digital to analog conversion module for performing a digital to analog conversion, an quadrature modulation unit for orthogonally frequency up-converting of a baseband signal into a IF signal, and a RF outputting module for processing the IF signal into a RF signal and outputting the RF signal.

Now a system according to the invention will be described in detail hereinafter using four embodiments.

### A First Embodiment of the System

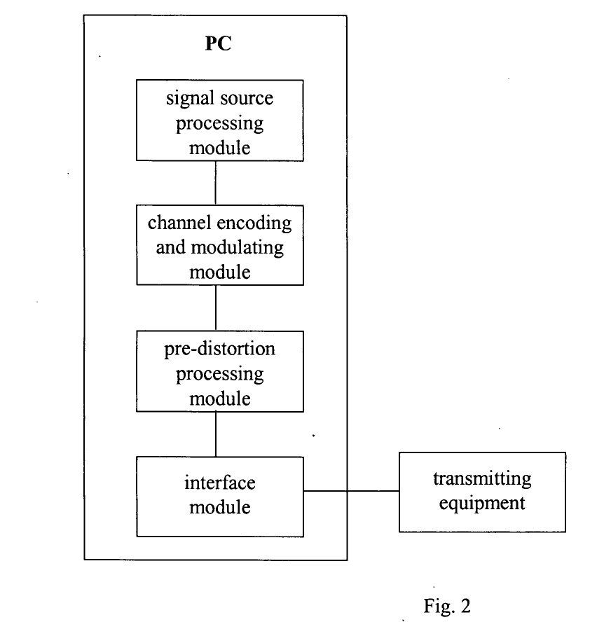

Referring to FIG. 2, the PC in the signal transmitting system further comprises a pre-distortion processing module connected between the channel encoding and modulating module and the interface module, which is arranged to, in the case of a high power amplifier being driven, perform the pre-distortion processing on data outputted by the channel encoding and modulating module, which data are then outputted by the interface module. The pre-distortion processing module is implemented based on PC software, which may thereby flexibly increase or decrease functions in the digital domain, and improve the compatibility of the system.

### A Second Embodiment of the System

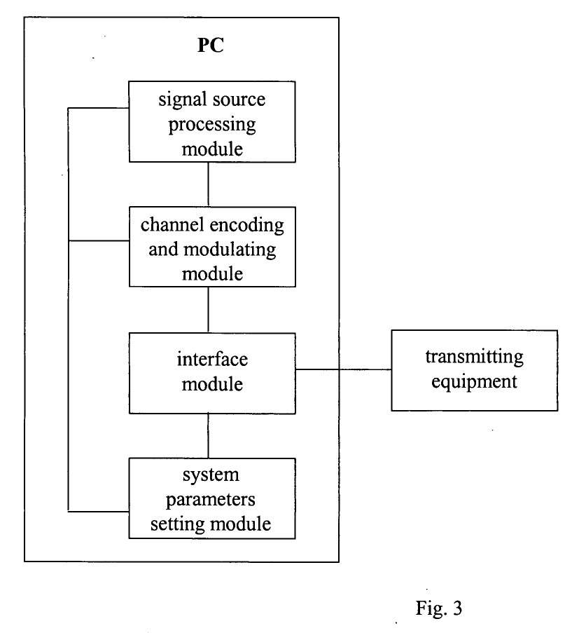

Referring to FIG. 3, the PC in the signal transmitting system further comprises a system parameters setting module for setting relevant parameters required by the signal source processing module, the channel encoding and modulating module and/or the transmitting equipment. The system parameters setting module may directly set or change the relevant parameters of the signal source processing module and the channel encoding and modulating module, and may set or change the relevant parameter(s) of the transmitting equipment by means of the interface module. The system parameters set or changed by the system parameters setting module may be called by the signal source processing module, the channel encoding and modulating module and/or the transmitting equipment. Since the system parameters setting module is realized based on a PC software platform, the system parameters may be more flexibly configured depending on a certain demand.

### A Third Embodiment of the System

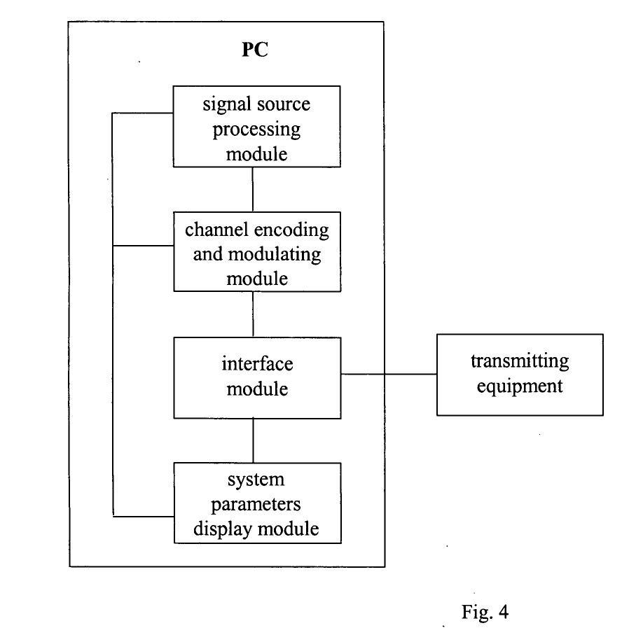

Referring to FIG. 4, the PC in the signal transmitting system further comprises a system parameters display module for displaying the parameters currently used by the signal source processing module, the channel encoding and modulating module and/or the transmitting equipment. The system parameters display module may directly display the parameters currently used by the signal source processing module and the channel encoding and modulating module, and may interact with the transmitting equipment via the interface module to display the parameter(s) currently used by the transmitting equipment. The system parameters display module is realized based on PC software, and may thus conveniently display the currently used system parameters, providing intuitionistic data for operation of an operator.

### A Fourth Embodiment of the System

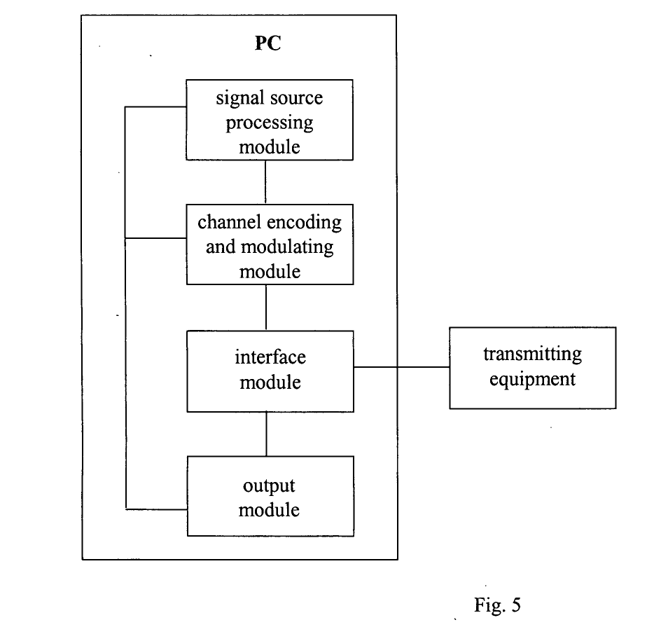

Referring to FIG. 5, the PC in the signal transmitting system further comprises an output module, which output module is connected to the signal source processing module and/or the channel encoding and modulating module, and arranged to output a signal processed by the signal source processing module and/or the channel encoding and modulating module, which output module may also be connected to each processing module comprised in the transmitting equipment, and output the signal or data generated after processing of the processing module. This enables the transmitting end to be a developmental environment, enriches test signals and increases testing means for a receiving device.

The PC in the above-mentioned signal transmitting system is not limited to including one of a pre-distortion processing module, a system parameters setting module, a system parameters display module and an output module, but may also include any combination of a pre-distortion processing module, a system parameters setting module, a system parameters display module and an output module.

The signal source processing module, the channel encoding and modulating module, the pre-distortion processing module, the system parameters setting module, the system parameters display module and the output module comprised by the PC in the above-mentioned signal transmitting system are all realized by means of PC software, and the corresponding programs are stored in a storage medium such as a hard disk, DVD-ROM, etc. for implementing the functions of the signal source processing module, the channel encoding and modulating module, the pre-distortion processing module, the system parameters setting module, the system parameters display module and the output module.

Corresponding to the above-mentioned signal transmitting system, the invention further provides a personal computer PC (i.e. the PC in the above-mentioned system) comprising a signal source processing module, a channel encoding and modulating module and an interface module that are successively connected.

Said signal source processing module is implemented by means of PC software and arranged to perform the signal source processing.

Said channel encoding and modulating module is implemented by means of PC software and arranged to perform the channel encoding and modulating of the processed signal source.

Said interface module, such as a USB interface or a PCI interface, is arranged to output data encoded and modulated by the channel encoding and modulating module.

Furthermore, the PC also comprises a pre-distortion processing module connected between the channel encoding and modulating module and the interface module, which is arranged to, in the case of a high power amplifier being driven, perform the pre-distortion processing on data outputted by the channel encoding and modulating module, which data are then outputted by the interface module. The pre-distortion processing module is implemented based on PC software, which may thereby flexibly increase or decrease functions in the digital domain, and improve the compatibility of the system.

Furthermore, the PC also comprises a system parameters setting module for setting relevant parameters required by the signal source processing module, the channel encoding and modulating module and/or an external device connected to the PC. The system parameters setting module may directly set or change the relevant parameters of the signal source processing module and the channel encoding and modulating module, and may set or change the relevant parameter(s) of the external device by means of the interface module. The system parameters set or changed by the system parameters setting module may be called by the signal source processing module, the channel encoding and modulating module and/or the external device connected to the PC. Since the system parameters setting module is realized based on a PC software platform, the system parameters may be more flexibly configured depending on a certain demand.

Furthermore, the PC also comprises a system parameters display module for displaying the parameters currently used by the signal source processing module, the channel encoding and modulating module and/or an external device connected to the PC. The system parameters display module may directly display the parameters currently used by the signal source processing module and the channel encoding and modulating module, and may interact with the external device via the interface module to display the parameter(s) currently used by the external device. The system parameters display module is realized based on PC software, and may thus conveniently display the currently used system parameters, providing intuitionistic data for operation of an operator.

Furthermore, the PC also comprises an output module, which output module is connected to the signal source processing module and/or the channel encoding and modulating module, and arranged to output a signal processed by the signal source processing module and/or the channel encoding and modulating module, which output module may also be connected to each processing module comprised in an external device, and output the signal or data generated after processing of the processing module. This enables the transmitting end to be a developmental environment, enriches test signals and increases testing means for a receiving device.

The above-mentioned PC is not limited to including one of a pre-distortion processing module, a system parameters setting module, a system parameters display module and an output module, but may also include any combination of a pre-distortion processing module, a system parameters setting module, a system parameters display module and an output module.

The signal source processing module the channel encoding and modulating module, the pre-distortion processing module, the system parameters setting module, the system parameters display module and the output module comprised by the above-mentioned PC are all realized by means of PC software, and the corresponding programs are stored in a storage medium such as a hard disk, DVD-ROM, etc. for implementing the functions of the signal source processing module, the channel encoding and modulating module, the pre-distortion processing module, the system parameters setting module, the system parameters display module and the output module.

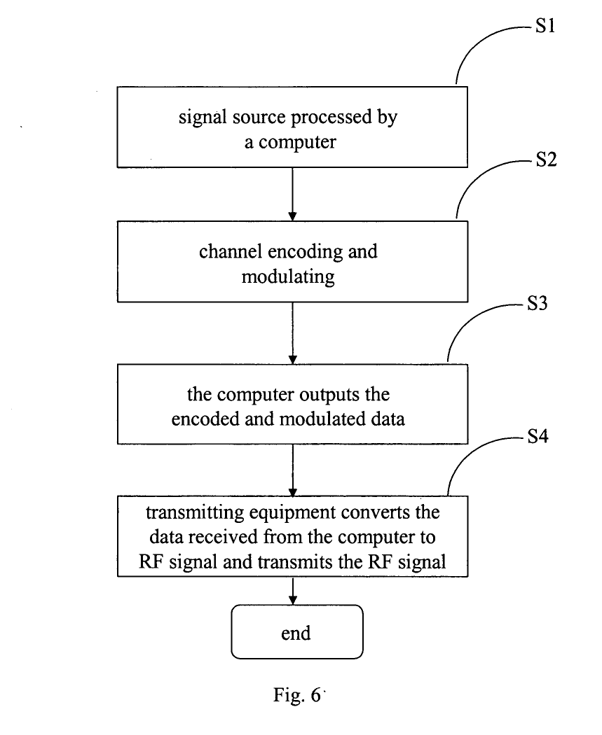

Corresponding to the above-mentioned signal transmitting system and PC, the invention further provides a signal transmitting method for a system having a PC and a transmitting equipment as shown in FIG. 6, which method comprises the following steps:

S1. The PC performs signal source processing.

S2. The PC carries out the channel encoding and modulating of the processed signal source.

S3. The PC outputs the encoded and modulated data.

S4. The transmitting equipment processes data received from said PC into a radio frequency (RF) signal and transmits the RF signal.

The detailed content in the individual steps of the method corresponds with the above-mentioned signal transmitting system and PC.

In combination with the above-mentioned signal transmitting system, PC and method, a specific processing flow is provided hereinafter, wherein the PC takes on the functions of software, the software running environment being a Windows or Unix environment. The software part carries out the signal source processing, the channel encoding and modulating, the pre-distortion processing, and the outputting of the intermediate signals in the signal transmitting system. Based on the PC software, the transmission of a RF signal is implemented.

1. The signal source processing module processes a signal source and converts it into a format that can be decoded by the receiving side (which may be outputted by the output module).

2. The PC encodes the data stream to be transmitted and increases its redundancy, i e. protects the load, in order to treat with disturbances introduced during channel transmission. The computations of scrambling, encoding, interleaving, mapping, frame forming, etc. for the inputted bit stream are performed by the channel encoding and modulating module. The encoded and modulated signal is filtered and then converted into a baseband I/Q signal (which may be outputted by the output module). The channel encoding and modulating part can employ different encoding and modulating modes depending on different transmission standards (schemes). Currently commonly used standards (protocols) are supported. The LVDS or LVTTL output modes may be employed. Setting of various parameters and modes of the channel encoding and modulating part of an exciter may be performed by a user via a user control interface of the PC.

3. The pre-distortion processing module performs pre-distortion processing on data outputted by the channel encoding and modulating module (which may be outputted by the output module) in the case of a high power amplifier being driven.

4. The encoded and modulated data are a binary file, and transmitted via the interface module to the transmitting equipment at a stable rate.

5. The transmitting equipment continues the data processing, which transmitting equipment mainly consists of a piece of FPGA, and achieves the following functions of:

A. correctly receiving data transmitted from the PC,

B. dividing the data received from the PC into two way signals I/Q, which are separately up-sampled and filtered,

C. correcting imbalances of the amplitude, phase, DC offset, cross-talk, etc. of the signals I/Q,

D. generating a 1 MHz monophonic test signal,

E. generating a universal pseudorandom sequence.

6. The digital to analog conversion, with the resolution of 14 bit and the balanced output.

7. The frequency up-conversion.

A baseband signal is modulated onto a desired frequency. The frequency conversion method adopted is the orthogonal frequency up-conversion and inhibit frequencies of a carrier and a mirror image, without the need of a band-pass filter. The output impedance is 50 Ohms. (The obtained signal may be outputted by the output module.)

8. A frequency synthesizer.

An local oscillation frequency of band U(L, S) is produced, which may be tuned at the step of 1 MHz. The phase noise is in accordance with the requirement of a digital television transmitting equipment.

9. The RF output, with the output impedance of 50 Ohms, which matches a π-typed network.

In summary, the invention employs the signal source processing and the channel encoding and modulating in the form of software, which avoids the use of an FPGA of a large capacity, and first of all can greatly reduce the cost of hardware. Certain cost of software research and development is necessary for developing the encode of an FPGA, and its expense is very high in this regard, whereas options for developing software on a PC are relatively many and still more flexible.

If the part of signal source and channel encoding is to be upgraded, it may be done by means of directly upgrading software, packaging it into a file of a specific format and sending it to a client via the Internet, without the need of a special engineer going to the client side for the upgrade.

The high power amplifier of a transmitter is subjected to an aging process, its state is gradually changing, and the adjustment of pre-distortion needs to be done continually, which is implemented in the software part in the present invention. This may be carried out directly by the PC, without the further need of other processes. Not only is the adjustment convenient, but also the reliability is enhanced.

The signal source processing and channel encoding and modulating is performed in the PC, various parameters of which may be adjusted and displayed directly via the PC interface, without the need of expense of additional hardware and software.

The expense of relatively expensive hardware such as an FPGA and the expense of software are reduced, thus greatly reducing the research and development cost and the material cost of a whole machine.

The invention may provide five kinds of signals including a digital baseband signal, an analog baseband signal, a digital IF signal, an analog IF signal and a RF signal, which greatly enriches the kinds of signal sources and provides convenience for debugging a receiving device.

To provide a desired test signal and meet the demand of testing the performance of a receiver module by module, an extracting unit or an extracting step may be added in the signal transmission system or method as described hereinbefore as an improved technical solution of the present invention, in order to extract a signal outputted by a relevant unit to a corresponding succeeding unit in the signal transmitting system. For clarity, a system and method for extracting a test signal will be illustrated as a separate solution, wherein the description of the above-mentioned signal transmission system and method will be briefly described, since said system for extracting a test signal may also be realized in a system and method other than the above-mentioned signal transmission system and method.

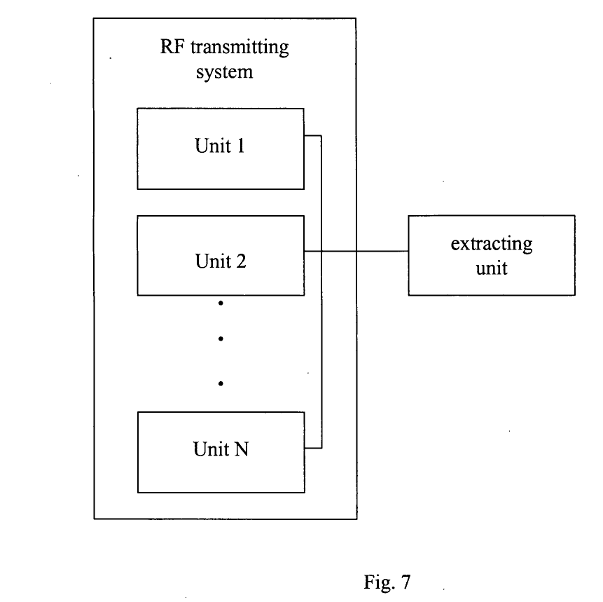

To provide a desired test signal and meet the demand of testing the performance of a receiver module by module, the present invention discloses a system for providing a test signal as shown in FIG. 7, which comprises each unit of a RF signal transmitting system, and an extracting unit.

The individual unit of the RF signal transmitting system is arranged to properly process data inputted by its preceding unit and then output the data to its succeeding unit.

The extracting unit is arranged to extract a signal outputted by a relevant unit to a corresponding succeeding unit in the RF signal transmitting system.

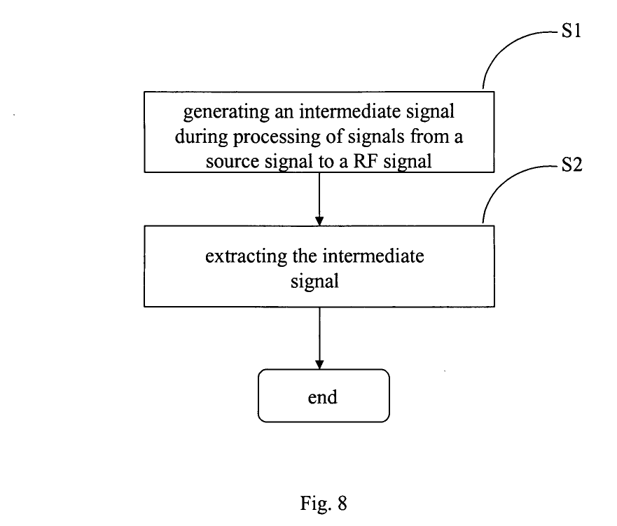

The invention further provides a method for providing a test signal as shown in FIG. 8, which comprises the following steps of:

S1. generating intermediate signals during processing of signals from a source signal to a RF signal,

S2. extracting the intermediate signals,

Said intermediate signals comprise a digital baseband signal, an analog baseband signal, a digital IF signal, and an analog IF signal. Once extracted, an intermediate signal may be supplied to another system for testing (for example, testing the performance of a receiver module by module). Based on the test result, the processing quality of the portions of processing procedures preceding to generation of the intermediate signal may be obtained during processing of signals from a source signal to a RF signal.

This will be described in detail hereinafter using four embodiments.

### A First Embodiment

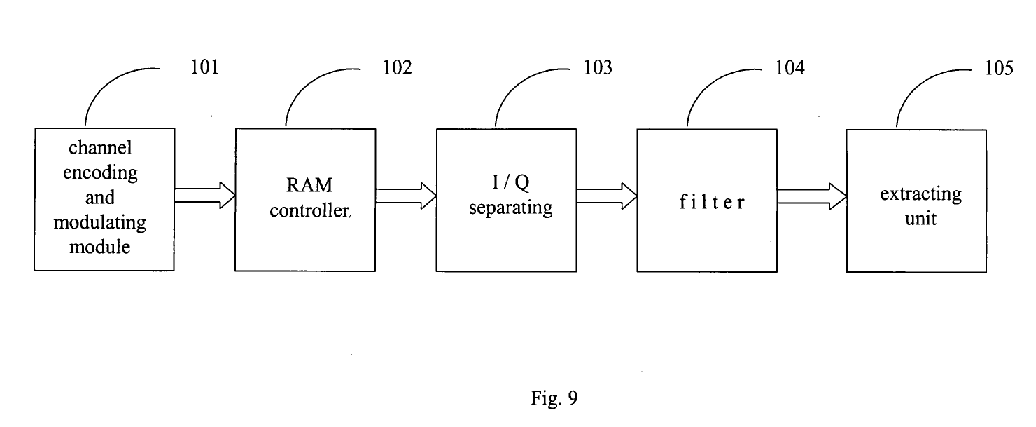

Referring to FIG. 9, a digital baseband signal is extracted based on the RF signal transmitting system, and the processing flow is as follows:

101. A channel encoding and modulating module performs the operation of channel encoding and modulation for the processed source signal and output the result.

102. A RAM buffers data outputted by the channel encoding and modulating module.

103. The data buffered by the RAM are divided into two way signals I, Q.

104. A filter filters the two way signals I, Q, generates and outputs a digital baseband signal (output in the form of TTL and LVDS (Low Voltage Differential Signaling)), wherein a further up-sampling process may be performed before the digital baseband signal is outputted (which needs the support of a filter).

105. An extracting unit extracts the digital baseband signal outputted by the filter.

The digital baseband signal extracted by the extracting unit may then be supplied to another system (which must match the type of interface of the extracting unit) for testing. As a consequence, the processing status of a unit that relates to generation of the digital baseband signal may be obtained, and if a problem exists, it is necessary only to look into the unit that relates to generation of the digital baseband signal, without the need of error correction in the whole RF signal transmitting system.

### A Second Embodiment

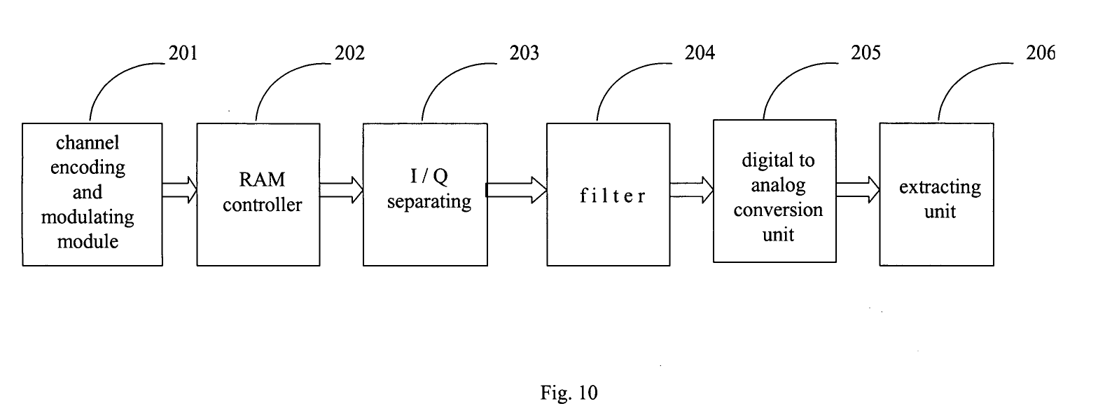

Referring to FIG. 10, an analog baseband signal is extracted based on the RF signal transmitting system, and the processing flow is as follows:

201. A channel encoding and modulating module performs the operation of channel encoding and modulation for the processed source signal and output the result.

202. A RAM buffers data outputted by the channel encoding and modulating module.

203. The data buffered by the RAM are divided into two way signals I, Q.

204. A filter filters the two way signals I, Q, generates and outputs a digital baseband signal (output in the form of TTL and LVDS), wherein a further up-sampling process may be performed before the digital baseband signal is outputted (which needs the support of a filter).

205. A digital to analog conversion unit converts the digital baseband signal outputted by the filter into an analog baseband signal and outputs the analog baseband signal (output in the form of TTL and LVDS).

206. An extracting unit extracts the analog baseband signal outputted by the digital to analog conversion unit.

The analog baseband signal extracted by the extracting unit may then be supplied to another system (which must match the type of interface of the extracting unit) for testing. As a consequence, the processing status of a unit that relates to generation of the analog baseband signal may be obtained, and if a problem exists, it is necessary only to look into the unit that relates to generation of the analog baseband signal, without the need of error correction in the whole RF signal transmitting system.

### A Third Embodiment

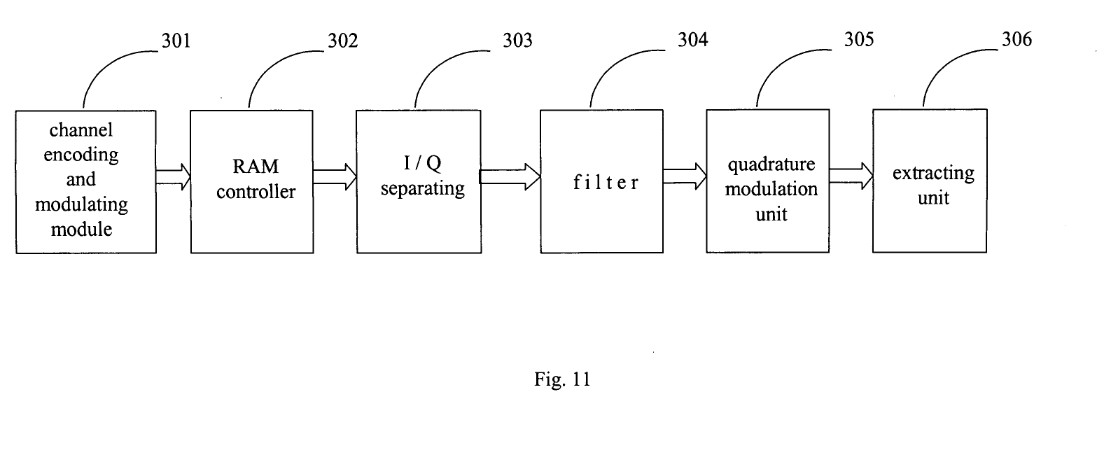

Referring to FIG. 11, a digital IF signal is extracted based on the RF signal transmitting system, and the processing flow is as follows:

301. A channel encoding and modulating module performs the operation of channel encoding and modulation for the processed source signal and output the result.

302. A RAM buffers data outputted by the channel encoding and modulating module.

303. The data buffered by the RAM are divided into two way signals I, Q.

304. A filter filters the two way signals I, Q, generates and outputs a digital baseband signal (output in the form of TTL and LVDS), wherein a further up-sampling process may be performed before the digital baseband signal is outputted (which needs the support of a filter).

305. An quadrature modulation unit performs the orthogonal frequency up-converting on the digital baseband signal outputted by the filter, generates and outputs a digital IF signal (output in the form of TTL and LVDS).

306. An extracting unit extracts the digital IF signal outputted by the quadrature modulation unit.

The digital IF signal extracted by the extracting unit may then be supplied to another system (which must match the type of interface of the extracting unit) for testing. As a consequence, the processing status of a unit that relates to generation of the digital IF signal may be obtained, and if a problem exists, it is necessary only to look into the unit that relates to generation of the digital IF signal without the need of error correction in the whole RF signal transmitting system.

### A Fourth Embodiment

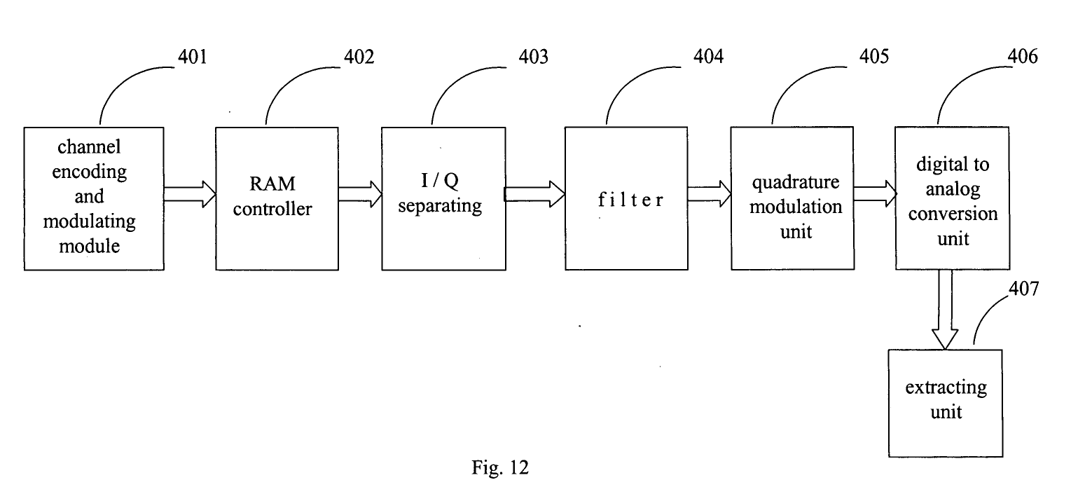

Referring to FIG. 12, an analog IF signal is extracted based on the RF signal transmitting system, and the processing flow is as follows:

401. A channel encoding and modulating module performs the operation of channel encoding and modulation for the processed source signal and output the result.

402. A RAM buffers data outputted by the channel encoding and modulating module.

403. The data buffered by the RAM are divided into two way signals I, Q.

404. A filter filters the two way signals I, Q, generates and output a digital baseband signal (output in the form of TTL and LVDS), wherein a further up-sampling process may be performed before the digital baseband signal is outputted (which needs the support of a filter).

405. An quadrature modulation unit performs the orthogonal frequency up-converting on the digital baseband signal outputted by the filter, generates and outputs a digital IF signal.

406. A digital to analog conversion unit (which may be similar to that of the second embodiment) converts the digital IF signal outputted by the quadrature modulation unit unit into an analog IF signal, and outputs the analog IF signal (output in the form of TTL and LVDS). If the frequency spectrum of the output needs flipping, it may be done by means of setting a digital processing register.

407. An extracting unit extracts the analog IF signal outputted by the digital to analog conversion unit.

The analog IF signal extracted by the extracting unit may then be supplied to another system (which must match the type of interface of the extracting unit) for testing. As a consequence, the processing status of a unit that relates to generation of the analog IF signal may be obtained, and if a problem exists, it is necessary only to look into the unit that relates to generation of the analog IF signal, without the need of error correction in the whole RF signal transmitting system.

In summary, the present invention may not only provide a RF signal as a test signal source, but also provide as a test signal source a digital baseband signal, an analog baseband signal, a digital IF signal, and an analog IF signal. This greatly enriches the kinds of signal sources, and brings about convenience for debugging a receiving device. Moreover, the invention is not limited to the above-mentioned four intermediate signals, and may also extract for other purposes intermediate data generated during processing of signals from a source signal to a RF signal, and the procedure of generating the above-mentioned four intermediate signals in the invention is not limited to those of the first embodiment to the fourth embodiment, and the scheme of combining the procedures of generating the above-mentioned four intermediate signals with the extracting procedure of an extracting unit should also fall in the scope of the present invention.

It should be noted that the above-mentioned embodiments illustrate rather than limit the invention and that those skilled in the art will be able to make various modifications and alterations without departing from the spirit and scope of the invention. Thus it is intended that the invention be constructed as including all such modifications and alterations insofar as they come within the scope of the appended claims or the equivalents thereof.

1. A signal transmitting system, characterized in that it is based on a computer operating system and comprises a computer and a transmitting equipment,
said computer comprising:
a data processing module for processing the source,
a channel encoding and modulating module for channel encoding and modulating data, and
an interface module for outputting the data encoded and modulated by the channel encoding and modulating module, and
said transmitting equipment being arranged to receive data from the interface module, converts the received data to RF signal, and then transmit the RF signal.

2. A system as claimed in claim 1, characterized in that between the channel encoding and modulating module and the interface module is also comprised a pre-distortion processing module for, in the case of a high power amplifier being driven, pre-distortion processing of data outputted by the channel encoding and modulating module, which data are then outputted by the interface module.

3. A system as claimed in claim 1, characterized in that said computer further comprises a system parameters setting module for setting relevant parameters required by the signal source processing module, the channel encoding and modulating module and/or the transmitting equipment.

4. A system as claimed in claim 1, characterized in that said computer further comprises a system parameters display module for displaying the parameters currently used
by the signal source processing module, the channel encoding and modulating module and/or the transmitting equipment.

5. A system as claimed in claim 1, characterized in that said computer further comprises an output module, which output module is connected to the signal source processing module and/or the channel encoding and modulating module, and arranged to output a signal processed by the signal source processing module and/or the channel encoding and modulating module.

6. A system as claimed in any of the claim 1, characterized in that said transmitting equipment comprises:
a digital to analog conversion module for performing a digital to analog conversion,
an quadrature modulation unit for orthogonal frequency up-converting of a baseband signal into a IF signal, and
a RF outputting module for processing the IF signal into a RF signal and outputting the RF signal.

7. A system as claimed in claim 1, characterized in that said signal transmitting system further comprises:
an extracting unit for extracting a signal outputted by a relevant unit to a corresponding succeeding unit in said signal transmitting system.

8. A system as claimed in claim 7, characterized in that said signal transmitting system further comprises:
a filter for filtering data outputted by the channel encoding and modulating module, generating and outputting a digital baseband signal, and
said extracting unit extracts the digital baseband signal outputted by the filter.

9. A system as claimed in claim 8, characterized in that said filter performs up-sampling processing before outputting the digital baseband signal.

10. A system as claimed in claim 7, characterized in that said signal transmitting system further comprises:
a filter for filtering data outputted by the channel encoding and modulating module, generating and outputting a digital baseband signal, and
a digital to analog conversion unit for converting the digital baseband signal outputted by the filter into an analog baseband signal and outputting the analog baseband signal, and
said extracting unit extracts the analog baseband signal outputted by the digital to analog conversion unit.

11. A system as claimed in claim 7, characterized in that said signal transmitting system further comprises:
a filter for filtering data outputted by the channel encoding and modulating module, generating and outputting a digital baseband signal, and
an quadrature modulation unit for orthogonal frequency up-converting of the digital baseband signal outputted by the filter into a digital IF signal and outputting the digital IF signal, and
said extracting unit extracts the digital IF signal outputted by the quadrature modulation unit.

12. A system as claimed in claim 7, characterized in that said signal transmitting system further comprises,
a filter for filtering data outputted by the channel encoding and modulating module, generating and outputting a digital baseband signal,
an quadrature modulation unit for orthogonal frequency up-converting of the digital baseband signal outputted by the filter into a digital IF signal and outputting the digital IF signal, and
a digital to analog conversion unit for converting the digital IF signal outputted by the quadrature modulation unit into an analog IF signal and outputting the analog IF signal, and
said extracting unit extracts the analog IF signal outputted by the digital to analog conversion unit.

13. A system as claimed in claim 12, characterized in that the digital to analog conversion unit performs frequency spectrum flipping before outputting the analog IF signal.

14. A system as claimed in any of the claim 7, characterized in that said extracting unit extracts a signal in the form of TTL or LVDS.

15. A personal computer, characterized in that it comprises:
a data processing module for processing a signal source,
a channel encoding and modulating module for channel encoding and modulating data, and
an interface module for outputting data encoded and modulated by the channel encoding and modulating module.

16. A personal computer as claimed in claim 15, characterized in that between the channel encoding and modulating module and the interface module is also comprised a pre-distortion processing module for, in the case of a high power amplifier being driven, pre-distortion processing of data outputted by the channel encoding and modulating module, which data are then outputted by the interface module.

17. A personal computer as claimed in claim 15, characterized in that said computer further comprises a system parameters setting module for setting relevant parameters required by the signal source processing module, the channel encoding and modulating module and/or an external device connected to the computer.

18. A personal computer as claimed in claim 15, characterized in that said computer further comprises a system parameters display module for displaying the parameters currently used by the signal source processing module, the channel encoding and modulating module and/or an external device connected to the computer.

19. A personal computer as claimed in claim 15, characterized in that said computer further comprises an output module, which output module is connected to the signal source processing module and/or the channel encoding and modulating module, and arranged to output a signal processed by the signal source processing module and/or the channel encoding and modulating module.

20. A signal transmitting method for use in a system having a computer and a transmitting equipment, characterized in that it comprises the following steps:
the personal computer performs signal source processing,
the computer carries out the operation of channel encoding and modulating on the processed signal source,
the computer outputs the encoded and modulated data, and
the transmitting equipment processes data received from said computer into a radio frequency RF signal and transmits the RF signal.

21. A method as claimed in claim 20, characterized in that said computer performs pre-distortion processing on the channel encoded and modulated data before 20 outputting the encoded and modulated data.

22. A method as claimed in claim 20, characterized in that parameters necessary for the signal source processing and the channel encoding and modulation operation performed by said computer, and for the data processing performed by the transmitting equipment are set in said computer.

23. A method as claimed in claim 20, characterized in that said computer, after processing a signal source, outputs a signal obtained by signal source processing, and/or said computer, after performing the operation of channel encoding and modulation, outputs a signal obtained by channel encoding and modulating.

24. A method as claimed in claim 20, characterized in that it comprises the following steps of:
generating an intermediate signal during processing of signals from a source signal to a RF signal, and
extracting the intermediate signal.

25. A method as claimed in claim 24, characterized in that said intermediate signal comprises a digital baseband signal, an analog baseband signal, a digital IF signal, and an analog IF signal.

26. A method as claimed in claim 24, characterized in that once extracted, an intermediate signal is tested, and based on the test result, the processing quality of the portions of processing procedures preceding to generation of the intermediate signal may be obtained during processing of signals from a source signal to a RF signal.
